(19) United States
(12) Patent Application Publication
(10) Pub. No.: US 2026/0092617 A1
(43) Pub. Date: Apr. 2, 2026

(54) MODULAR SYSTEM

(71) Applicant: 3 Legged Thing Limited, Bedfordshire (GB)

(72) Inventor: Danny Lenihan, Bedfordshire (GB)

(73) Assignee: 3 Legged Thing Limited, Bedfordshire (GB)

(21) Appl. No.: 19/341,525

(22) Filed: Sep. 26, 2025

(30) Foreign Application Priority Data
Sep. 30, 2024 (GB) 2414352.1

(51) Int. Cl. F16B 5/00; F16M 13/04; G03B 17/56

(52) U.S. Cl. CPC F16B 5/0088; F16B 2200/67; F16M 13/04; G03B 17/561

(57) ABSTRACT

A modular system for attachment of blocks of a connection assembly comprising: at least two blocks comprising a first block and a second block; a connector configured to secure the first block and the second block together; wherein the first block comprises a port having a first opening on a first face and a second opening on a second face, wherein at least one of the first opening and second opening is configured to receive at least a portion of the connector; and a first fastener configured to engage each of the connector and the port of the first block to removably secure the connector in the port.

### FIELD OF THE INVENTION

The present invention relates to a modular system, typically, relating to a modular system for attachment of blocks for a connection assembly, such as for photographic, videographic, music or outdoor purposes.

### BACKGROUND

Photographers and cinematographers commonly mount cameras and other photographic devices on supports such as tripods and monopods. Supports are typically provided with a tripod or monopod head and screw for direct mounting of the camera or other photographic device. For such mounting means, the contact point of the support with the camera is small. This causes a risk of the camera rotating due to the camera lens providing torque on the camera body and screw. Consequently, this shifts the centre of mass of the device on the support resulting in a loss of stability.

Mounting devices or assemblies, such as base plates, can be used to provide a larger contact area between the support and the camera base. This reduces rotation about the screw by increasing the friction on the camera base and holding it in place once tightened. To further aid in the stability of the mounted device, base plates can be provided with side elements to redistribute the weight of the device to maintain the centre of mass above the support. An example of these mounting assemblies is an L-bracket, which are becoming increasingly popular with photographers and videographers.

An L-bracket consists of a base potion and an arm portion positioned at a right angle to the base portion to provide the “L” shape that gives the bracket its name. Each of the base portion and the arm portion typically have a means for connecting the bracket to a support, which typically includes a quick-release engagement means. The quick-release engagement means is able to co-operate with a complementary engagement element on the support for easy attachment and detachment. In this way, the camera is securely mounted on the base portion of the L-bracket such that the arm portion extends parallel to a side of the device.

However, conventional L-brackets lack sufficient adjustability to accommodate the varying dimensions of different cameras and are limited in their ergonomic handling abilities. Further, most L-brackets only support horizontal and vertical orientations, and therefore are further limited in versatility. Moreover, because these brackets are typically designed with the base plate fixed to the arm portion, they can become unstable when the centre of mass shifts, compromising the overall stability of the camera setup. Additionally, a number of other accessories or pieces of equipment may be in use at the same time, with a desire to use those together and in close proximity. However, this typically requires multiple means of support.

Therefore, there exists a need for a more customisable photographic assembly which can be tailored to accommodate various camera models and setups. There further exists a need for increased versatility during use of the device by the photographer while still ensuring stability of the device. Moreover, these problems are not limited to photographic assemblies. The problems are also apparent in other industries such as with musical equipment, fishing, cycling, shooting, walking/hiking/mountaineering, camping equipment and other outdoor equipment. Broadly, similar issues are faced in industries where there are a number of pieces of equipment used and that may wish to be used at the same time.

There is therefore a need for a product that addresses at least some of the above problems.

### SUMMARY OF THE INVENTION

According to a first aspect, there is provided a modular system for attachment of blocks of a connection assembly comprising: at least two blocks comprising a first block and a second block; a connector configured to secure the first block and the second block together; wherein the first block comprises a port having a first opening on a first face (of the said block) and a second opening on a second face of (the said block), wherein at least one of the first opening and second opening is configured to receive at least a portion of the connector; and a first fastener configured to engage each of the connector and the port of the first block to removably secure the connector in the port (of the first block).

Modular systems traditionally comprise of two or more standard components that can be assembled in various configurations to form complex structures. An aspect relates to a modular system comprising at least two blocks which can be attached together in various configurations using a connector to secure the blocks together so as to form complex structures. At least the first block comprises a port having a first opening on a first face and a second opening on a second face. At least one of the openings can receive at least a portion of the connector. The connector can then be removably secured in the port using a first fastener configured to engage each of the connector and the port of the first block. In this way, the system is securely held in place using the fastener to provide the complex structure. By providing a removably secured connection, the fastener can be removed and the system can be reconfigured into a different structure.

The modular system of the present invention is particularly useful for attachment of blocks of a connection assembly. A “connection assembly” is intended to refer to an assembly having components intended to be secured together such as plates, brackets, bolts, nuts, screws or other fasteners etc.

In some examples, the connection assembly is a photographic assembly. A photographic assembly refers to an assembly comprising two or more photographic blocks or components. For example, conventional L-brackets lack sufficient adjustability to accommodate various camera types. The present invention overcomes this problem by providing a customisable modular system which can be configured to provide an L-bracket assembly suitable for a given camera type. Further, the present invention enables interchangeability between the side elements and/or the base elements of the L-bracket, as well interchangeability of the the tripod and camera mount. Not only can the components be switched and changed to suit the purpose of the photographic system, but the present invention also allows for the orientation of components relative to one another be varied. Both the interchangeable and reconfigurable nature of the device improves not only the versatility of the device, but also improve the stability of the photographic assembly. Blocks can be reconfigured and arranged to shift the centre of mass of the photographic assembly, enhancing its overall stability.

Therefore, the present modular system is particularly suitable for attachment and reconfiguration of components typical of a photographic assembly.

While the first face and second face may be separated from each other, such as by an intermediate face, typically, the first face and second face may be connecting faces of the first block.

The term “connecting faces” is intended to refer to two faces connecting or joined to one another along a common edge, such as faces with abutting edges or faces that share an edge. In this way, the first face and second face of the present invention are connected or joined to one another along a common edge.

In some examples, the first opening and the second opening are each configured to receive at least a portion of the connector

By having both the first opening and the second opening configured to receive at least a portion of the connector, a user can choose which opening of the two openings to insert the connector into. Therefore, the same first and second blocks can be combined in an increased number of different ways by using the different openings to receiving the connector. In this way, this feature increases the attachment and reconfiguration options of the modular system. This improves the versatility of the system, thereby enabling the system to adapt to a wider range of different requirements and functional needs.

In some examples, the port comprises a through-hole extending between at least the first opening and the second opening.

The term “through-hole” is intended to refer to a hole or bore which passes through or extends between the first opening and second opening of the port. In this way, the through-hole provides a channel between the first and second openings.

In some examples, the first opening and the second opening are arranged such that, when at least a portion of the connector is received by one of the first opening or second opening, the other of the first opening or second opening is able to receive the fastener for engagement with the connector.

For example, the at least a portion of the connector is inserted by a user into the first opening such that the at least a portion of the connect sits in a portion of the through-hole. In this example, the first opening may be configured such that the at least a portion of the connector fits tightly in the first opening and/or through-hole to ensure that the at least a portion of the connector is in the correct position for fastening. Once the at least a portion of the connector is inserted and is in place in the through-hole, the fastener is received by the second opening so as to secure the at least a portion of the connector in the port of the first block. In this way, the fastener provides a reliable connection, holding the at least a portion of the connector in the port. The fastener is accessible through the second opening such that it can easily be removed. This allows for the modular system to easily be assembled and disassembled for reattachment.

Advantageously, since both openings may be configured to receive the at least a portion of the connector, the openings may be used interchangeably, allowing for the blocks to be attached at different orientations to one another. Therefore, in some examples, the second opening (instead of the first opening as described above) receives the at least a portion of the connector. In this example, the first opening (instead of the second opening) receives the fastener.

In some examples, the first fastener is a screw. In some examples, the fastener may comprise one or more screws. The screw(s) ensure a reliable connection that holds the connector in place in the port, thereby minimising movement of the connector in the port. Screws can be removed and reinserted as needed. The use of a plurality of screws provides an advantage over use of only a single screw because this limits the ability of the connector to rotate about the single screw due to provision of multiple points of attachment. While the connector and the respective block into which the connector is inserted into a port thereof may each have a screw thread capable of accepting the screw, typically, (only) the connector has a threaded bore arranged to receive the screw. In those circumstances, the port or block may be unthreaded, at least where the fastener is accepted. This means the attachment is achieved by the head of the screw abutting a portion of the port or block when screwed into the connector a sufficient amount, thereby providing the fastening.

In other examples, any alternative fastener to a screw may be used. For example, the fastener may be a bolt or clip.

In other examples, the first fastener is a spring-loaded latch. Preferably, the spring-loaded latch is arranged on the at least a portion of the connector.

A spring-loaded latch is a latch mechanism which employs at least a spring to provide a secure hold between two or more components. In the present invention, the spring-loaded latch is configured such that, the first or second opening receives the at least a portion of the connector when the at least a spring is in a compressed configuration. The at least a spring sits in the port of the first block once inserted. The constant pressure from the spring provided on an inner wall of the port provides a reliable hold between the at least a portion of the connector and the first block, thereby securing them together.

In some examples, the spring-loaded latch is arranged on the at least a portion of the connector and configured such that when the at least a portion of the connector is received by one of the first opening or second opening, the spring-loaded latch is in an uncompressed state in the other of the first opening or second opening. This provides a reliable hold as the at least a portion of the connector cannot be removed without compression of the spring-loaded latch to remove the connector. Is can be due to a side of the latch engages with a wall that blocks egress of the connector due to urging from a bias of the spring until the spring bias is overcome by some other action.

In some examples, the spring-loaded latch requires rotational movement to ensure a secure hold. The spring-loaded latch is arranged on the at least a portion of the connector and configured such that when the at least a portion of the connector is received by one of the first opening or second opening and the connector is rotated, the spring-loaded latch is in an uncompressed state in the other of the first opening or second opening. The at least a spring is compressed when received by the first opening. Rotation of the at least a portion of the connector allows the spring to return to an uncompressed position when the spring is located in the second opening. To remove the connector from the port, the at least one spring is compressed. This will allow the connector to be removed from the port at the opening it was received by.

The fastener may comprise any combination of the securing means such as any combination of a spring-loaded latch, a screw etc.

In some examples, the connector comprises a flange portion arranged such that, when the at least a portion of the connector is received by one of the first opening or second opening, the flange portion is located between or extends between the first block and the second block.

Preferably the flange portion is a raised portion of the connector. Preferably, the raised portion is a raised profile arranged around the circumference of the connector. Preferably, the flange portion is arranged at a central region of the connector. The flange portion provides a stable point of contact between the two blocks. Preferably, a first surface of the flange is in contact with a face of the first block and a second surface of the flange is in contact with a face of the second block. In this way, the flange portion provides support at a connection point between the first and second block, thereby improving the stability of the connection between the blocks.

In some examples, the port comprises a third opening arranged on a third face of the said block. In some examples, the first face, second face and third face of the first block are arranged on connecting faces of the said block. In some examples, the port third opening is configured to receive at least a portion of the connector.

In some examples, the port further comprises one or more of: a fourth opening arranged on a fourth face of the said block, a fifth opening arranged on a fifth face of the first block, a sixth opening arranged on a sixth face of the said block. One or more of the fourth, fifth and sixth opening are each configured to receive at least a portion of the connector.

In some examples, the second block comprises a port having a first opening on a first face (of the said block) and a second opening on a second face (of the said block), wherein at least one of the first opening and second opening is configured to receive at least a portion of the connector; and a second fastener is configured to engage each of the connector and the second port of the second block to removably secure the connector in the port (of the second block).

The port of the second block may have any of the features described above in relation to the port of the first block. The port of the first block may comprise the same configuration or a different configuration to that of the port of the second block. In some examples, the port of the first block is identical to the port of the second block. The port of each of the first and second block may be arranged in any suitable location of the said block. Preferably the port is arranged proximal to an edge of said block, such as within 1.00 centimetre (cm) of an edge, 0.50 cm of an edge or 0.25 cm of an edge.

In some examples, the connector is configured such that at least one of the first opening and second opening of the first block receives a first portion of the connector and at least one of the first opening and second opening of the second block receives a second portion of the connector. The first portion of the connector is a different portion of the connector to the second portion of the connector. In this way, both the port of the first block and the port of the second block can be fastened at different portions of the connector. Therefore, both the first and second block can be held together using the connector.

In some examples, at least one of the first block and second block comprises two or more ports. In some examples, at least one of the first block and second block comprise a plurality of ports. The ports may be identical to any of the ports described herein. In this way, there are an increased number of positions in which the connector can be secured to the said block. This increases the number of orientations by which the blocks can be connected together, thereby increasing the versatility of the modular system.

In some examples, the connector is integrally secured to the second block. In other words, the connector and the second block are joint together by a permanent fixture or are a (single) unitary body. This simplifies the design and manufacturing process of the second block as it may be manufactured as one unit. Alternatively, the connector may be welded or fixed in some other manner to the second block. By having the connector integrally secured to the second block there is a reliable connection between these components. The connector is integrally secured to the second block such that the at least a portion of the connector may still be received by the first block.

In some examples, the connector comprises an extension plate portion and the second block is a base plate, wherein the extension plate portion is securable to the second block in a plurality of positions, an amount of overlap of the extension plate portion and the second block being determined by the position in which the extension plate portion is secured to the second block, the position of the first block relative to the second block thereby being movable.

In this example, the at least a portion of the connector is distinct from the extension plate portion of the connector. Therefore, the at least a portion of the connector is received by the first block as described herein and extension plate portion is securable to the second block in a plurality of positions as described above. The base plate is a base against which the photographic device is placeable in use, the base comprising an engagement structure arranged in use to provide engagement of the base with the support. The base plate may comprise a first recess (the first recess being) shaped to receive the extension plate portion.

In some examples, the first block and second block are identical blocks.

In some examples, at least one of the first and second block is a plate. In some examples, the plate is one of: a base plate of a photographic assembly, and a side plate of the photographic assembly.

In some examples, the at least one of the first and second block is a side element of a photographic assembly, such as a side aspect of an L-bracket; a mount for a flash, monitor, shade or reflector; or a cable grip or hook.

In some examples, the at least two blocks comprise two or more first blocks and/or two or more second blocks. In this way, the system comprises a number of different blocks which may be connected together to make different structures. This increases the versatility of the system.

In some examples, at least one of the first block and second block is mountable to a support. In some examples, the support is a camera tripod. In some examples, the modular system further comprises a docking member removably securable to at least one of the first block and second block and having a shape arranged to provide engagement with the support.

### BRIEF DESCRIPTION OF DRAWINGS

An example modular system is described in detail below with reference to the accompanying drawings, of which:

FIG. 1A and FIG. 1B schematically illustrate an exemplary block;

FIG. 1C and FIG. 1D schematically illustrate an exemplary connector;

FIG. 2A illustrates an exemplary configuration of the modular system;

FIG. 2B illustrates a portion of an exemplary configuration of the modular system;

FIG. 3A illustrates an exemplary configuration of the modular system;

FIG. 3B illustrates an exemplary configuration of the modular system;

FIG. 4A illustrates an exemplary configuration of the modular system;

FIG. 4B illustrates an exemplary configuration of the modular system;

FIG. 4C illustrates an exemplary configuration of the modular system;

FIG. 4D illustrates an exemplary configuration of the modular system;

FIG. 4E schematically illustrate an exemplary connector;

FIG. 5A illustrates an exemplary configuration of the modular system;

FIG. 5B illustrates an exemplary configuration of the modular system;

FIG. 6 illustrates an exemplary configuration of the modular system;

FIG. 7 illustrates exemplary blocks.

### DETAILED DESCRIPTION

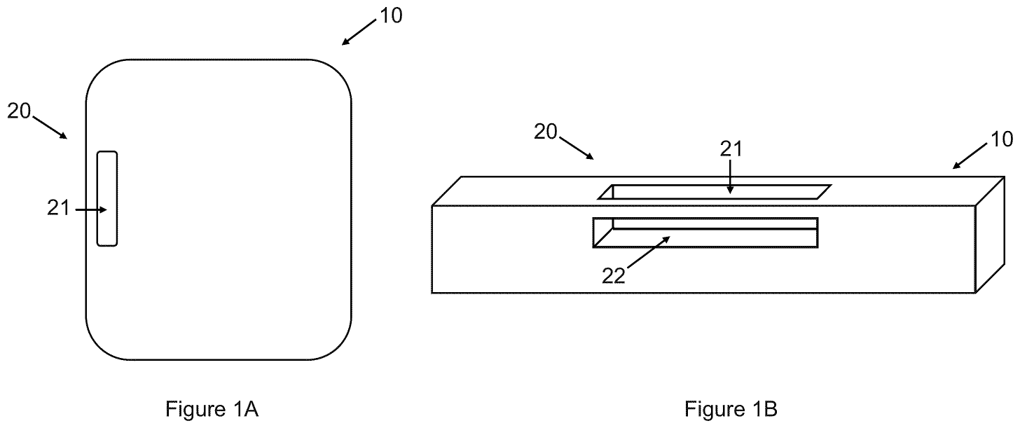

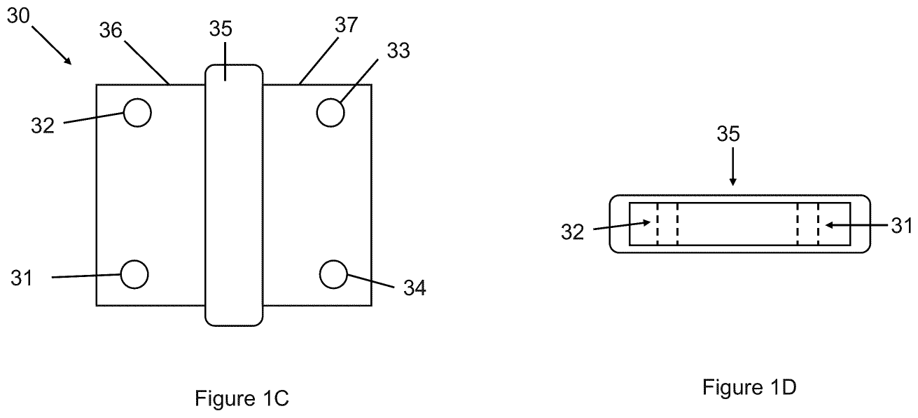

The modular system 1 of an aspect comprises at least two blocks. FIG. 1A schematically illustrates a plan view of an example first block 10 of the at least two blocks according to an aspect. FIG. 1B schematically illustrates a side view of the first block 10 according to an aspect. The first block 10 may be a plate of a photographic assembly, such as a base or a side element intended to extend vertically from a base plate. The first block 10 is not limited to a plate and may be any component of a photographic assembly or other example assembly.

As shown in FIG. 1A, the first block 10 comprises a port 20. The port 20 is arranged proximal (such as adjacent) to a first edge of the first block 10 so as to allow for the attachment of other blocks of the modular system to be attached at this portion of the first block 10. In this example, the port 20 is arranged parallel to the proximal edge. This arrangement aids in alignment between blocks of the modular system 1.

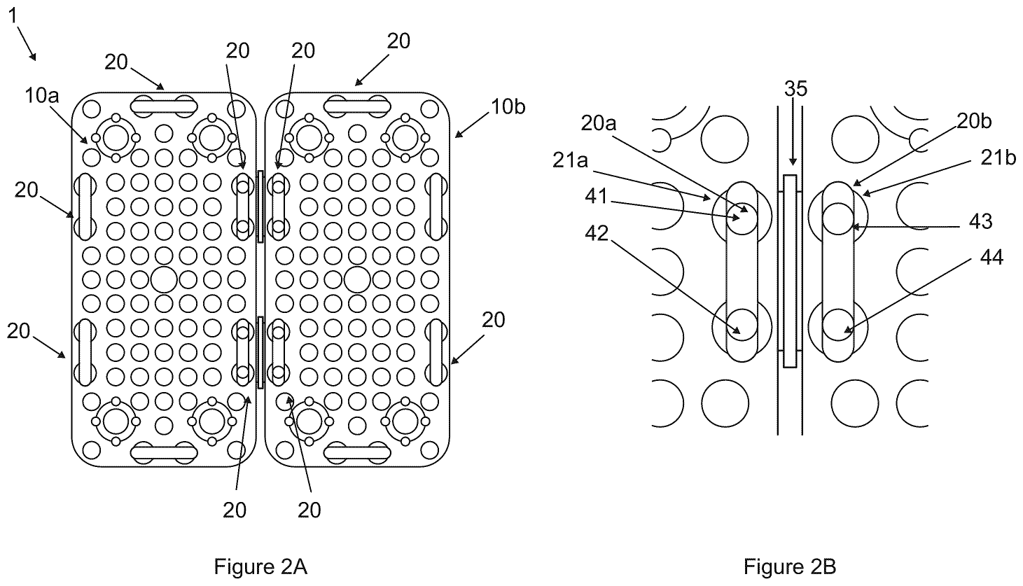

The port 20 comprises a first opening 21 on a first face of the first block 10. In this example, the first face is a top face. As shown in FIG. 1B, the port 20 further comprises a second opening 22 on a second face of the first block 10. In this example, the second face is a side surface of the block 10. As shown in FIG. 2B, in some examples, the first face and second face are connecting faces of the first block 10, such that they share an edge of the first block 10.

In this example, both the first opening 21 and second opening 22 are configured to receive at least a portion of a connector. In this way, both the first opening 21 and second opening 22 are shaped such that a portion of the connector can be received by said opening. By having two openings configured in this way, there are an improved number of configurations in which the first block 10 can receive the connector, thereby increasing the versatility of the modular system 1.

In various examples, the port 20 comprises a through-hole extending between the first opening 21 and the second opening 22, thereby providing a channel between the first opening 21 and second opening 22. In this way, a connector can be inserted into one of the two openings, and a fastener can be inserted in the other of the two openings so as to secure the connector in the port 20 of the first block 10.

FIG. 1C schematically illustrates a plan view of an exemplary connector 30 of the modular system 1. FIG. 1D schematically illustrates a side view of the exemplary connector 30 of the modular system 1. The connector 30 has a connector body comprising connector portion 36 and connector portion 37. The connector 30 is configured to secure the first block 10 and a second block together. The connector 30 of this example comprises a number of holes 31, 32, 33, 34 each configured to receive a screw. In other examples, the fastener type may be different such that holes 31, 32, 33, 34 in the connector 30 are not required. In other examples, any number of suitable holes 31, 32, 33, 34 may be used.

As shown in FIG. 1D, the holes 31, 32, 33, 34 are through-holes extending through the width of the connector 30. In other examples, the holes are blind bores. In some such examples, each surface of the connector have holes in corresponding locations. In various examples, the holes are threaded bores.

In several examples, the connector 30 has a central flange portion 35 which is a “lip” extending beyond the main connector body 36, 37. As shown in FIG. 1C and FIG. 1D, in some examples, the flange portion 35 a raised profile around the circumference of the connector 30. In this way, the flange portion 35 has a greater width, height and thickness than the connector body. Therefore, in various examples, the openings of the first block 20 are shaped such that they receive a portion of the connector body 36, 37 but are also shaped such that the flange portion is not received by the opening. In this way, the flange portion is arranged outside of the port 20 when the connector 30 is received by the first block 10 so as to provide a stable point of connection between the first block 10 and a second block.

FIGS. 2A and 2B shows how an example connector 30 of FIGS. 1C and 1D may be used to connect two identical example blocks 10a, 10b together. The blocks 10a, 10b in FIGS. 2A and 2B are example components of a photographic assembly.

Each block 10a 10b shown in FIGS. 2A and 2B comprise a plurality of identical ports 20, each configured to receive at least a portion of the connector 30. As shown, each port 20 has a first opening 21 on the top face of the respective block 10a 10b. In various examples, such as those shown in FIGS. 2A and 2B, each port 20 also has a second opening on the side face of the block 10a 10b and a third opening on the bottom face of the block 10a, 10b. Each of these openings are arranged on connecting faces of the block 10a, 10b. In several examples, a through-hole connects these openings.

As shown, in various examples, each opening is shaped such that it comprises two circular portions at either end of the opening with a connecting passage between said circular portions. Each opening has a length and width such that a portion of the connector body 36, 37 can be received by each of the openings. The circular portions of each opening are shaped so as to accommodate a fastener, in the examples, shown by providing a countersunk recess for a screwhead.

In some specific examples, two connectors 30 are used to attach the two blocks 10a, 10b together using two ports 20 of each block 10a, 10b such that the blocks 10a, 10b lie in the same longitudinal plane to one another. Using two connectors 20 instead of one improves the stability of the structure of the connected system. In other examples, more connectors may be used to secure the two blocks 10a, 10b together. In some circumstances, only a single connector is used.

To provide further details on how the blocks 10a, 10b are connected together, FIG. 2B shows a magnified view of the connector 30 shown in FIGS. 1C and 1D. The ports 20a, 20b of each block 10a, 10b comprises a first opening 21a, 21b on a top face of the respective block 10a, 10b, a second opening on an adjacent side face of the respective block 10a, 10b and a third opening on a bottom face of the respective block 10a, 10b.

As shown, the second opening of block 10a receives a first portion of the connector body 36. The second opening of block 10b receives a second portion of the connector body 37. Since the portion of the connector body 36 and the portion of the connector body 37 are mirrored portions, in other configurations of the modular system 1, the portions 36, 37 received by the second opening of the ports 20a, 20b may be switched.

A first fastener comprising screws 41 and 42 is inserted through the first or third opening of port 20a into holes 31 and 32 respectively so as to removably secure the connector 30 in the first port 20a of the block 10a. A second fastener comprising screws 43 and 44 are inserted through the first or third opening into holes 33 and 34 respectively so as to removably secure the connector 30 in the port 20b of the block 10b. Therefore, the first fastener and second fastener engage each of the portions of the connector body 36, 37 and the respective ports 20a, 21b of blocks 10a, 10b.

As shown in FIG. 2B, the connector 30 comprises a flange portion 35 arranged on the connector 30 such that it is located between block 10a and block 10b. Adjacent surfaces of the flange portion 35 are parallel to the side surfaces of the blocks 10a, 10b such to provide support at the connection point between the blocks 10a, 10b. This improves the reliability of the connection between the blocks 10a, 10b.

In other configurations of the system 1, since all the openings of each port 20 are configured to receive a portion of the connector body 36, 37, the blocks 10a, 10b can be secured together using any one of the other openings of the ports 20a, 20b. Further, due to the identical nature of the plurality of ports 30 of each block 10a, 10b, the blocks 10a, 10b may have been attached in a similar manner using two of the plurality of other ports 20. This would allow the blocks 10a, 10b to be attached to one another on various orientations and configurations, thereby ensuring the versatility of the system.

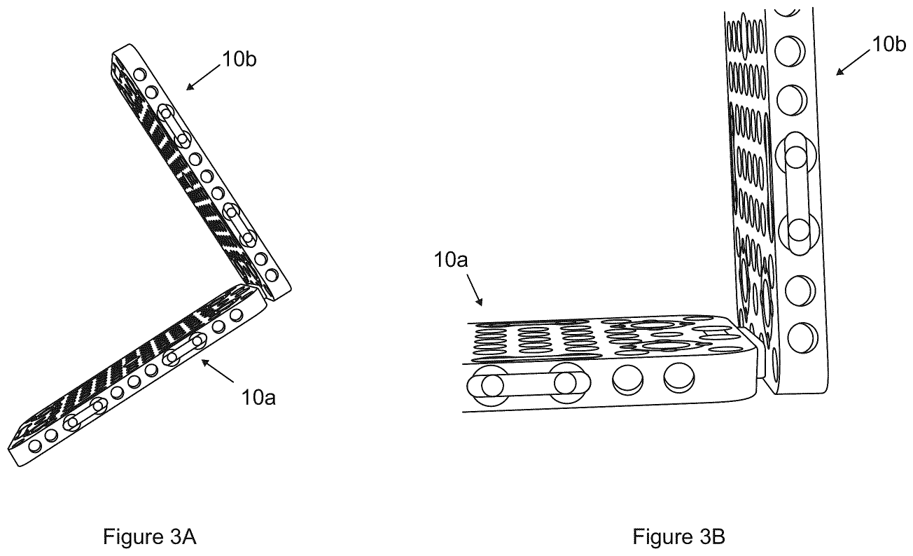

For example, FIGS. 3A and 3B show an alternative configuration of the blocks 10a and 10b shown in FIGS. 2A and 2B. Block 10a is arranged at a right angle (i.e. 90 degrees) to block 10b, thereby providing an L-shaped structure. This configuration is particularly useful for providing a L-bracket.

In this example, instead, the second opening of block 10b receiving the portion of the connector body 37, the first opening of block 10b on the top face of the block 10b has received the portion of the connector body 37. In other words, a different opening of port 20b to that of the same port 20b in FIGS. 2A and 2B has received the portion of the connector body 37.

As demonstrated by the above examples, the present modular system 1 allows for the reconfiguration of components typical of a photographic assembly. The blocks 10a, 10b may be attached and reconfigured in a number of different orientations so as to provide the desired photographic assembly.

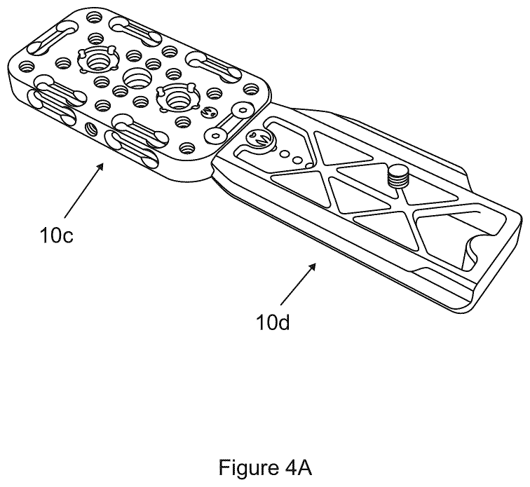

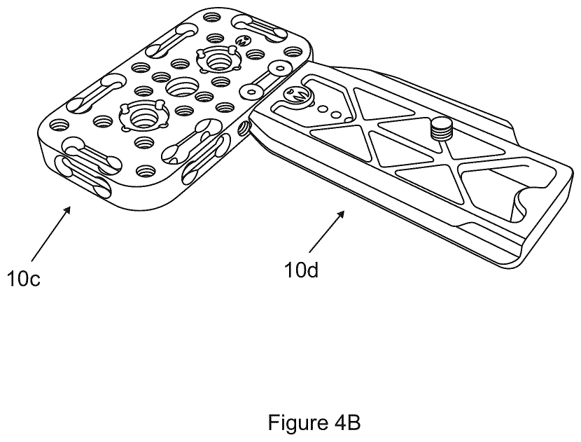

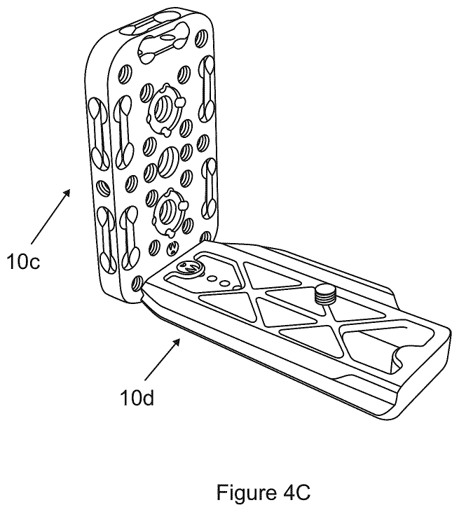

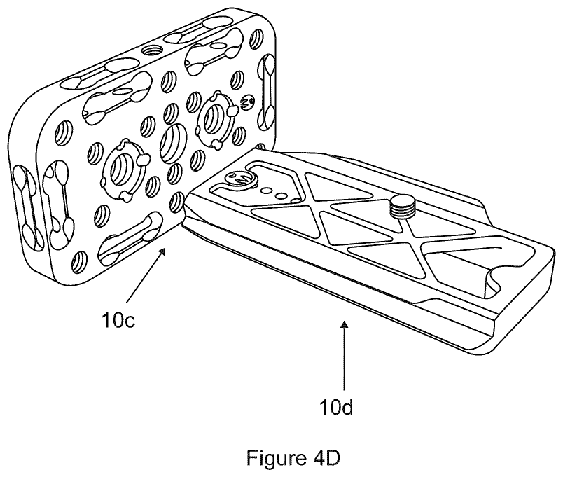

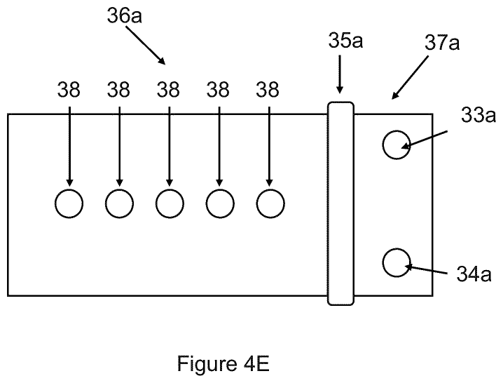

In the above example, block 10a and block 10b are identical. However, in other examples, the blocks 10a, 10b may be different. FIGS. 4A-4D show an exemplary configuration wherein the blocks 10a, 10b are different to one another. Block 10c in FIG. 4A is a side element of a photographic assembly. Block 10d is a base plate of a photographic assembly. A base plate is a base against which the photographic device is placeable in use. In this example, the base comprising an engagement structure arranged in use to provide engagement of the base with a support. As shown, the fastener is provided by a screw, which is engaged with the base in use and arranged in use to removably connect to the photographic device (e.g. a camera).

In FIG. 4A, block 10c and block 10d are arranged in a similar manner to that of FIGS. 2A and 2B in that the blocks 10c, 10d are connected so as to lie in the same longitudinal plane. In this example, only one connector 30 is used to attach the blocks 10c 10d together.

FIG. 4B also shows an alternative configuration of blocks 10c, 10d. The blocks 10c, 10d lie in the same longitudinal plane, but with a different orientation to that shown in FIG. 4A. This different relative orientation is achieved by securing the connector to a different port of block 10c. FIG. 4C shows yet another alternative configuration of blocks 10c and 10d. Block 10c is arranged at a right angle to block 10d. FIG. 4D also shows a configuration wherein block 10c is arranged at a right angle to block 10d.

The connector 30 of the modular system is not limited to that shown in FIGS. 1C and 1D. The connector 30 shown in FIGS. 1C and 1D is symmetrical about a longitudinal axis at the flange portion 35. In this way, the connector 30 shown in FIGS. 1C and 1D is advantageous in modular systems 1 having identical blocks 10a, 10b. However, in modular systems wherein the blocks 10c, 10d are not identical, the connector 30 may be adapted for attachment to each of these specific blocks 10c, 10d.

As shown in FIG. 4E, the connector 30a used in FIGS. 4A to 4D is not symmetrical about a longitudinal axis at the flange portion 35a. Instead, the portion of the connector body 36a is specifically configured to be secured in a port of block 10d, while the portion of the connector body 37a is specifically configured to be secured in a port of block 10c. In this way, a port of block 10d is not configured to receive the portion of the connector body 37a and a port of block 10c is not configured to receive the portion of the connector body 36a.

The portion of the connector body 37a can be secured in a port of block 10c in any of the above-mentioned ways. However, the portion of the connector body 36a must be received by the side opening of a port of block 10d, and is secured in the below described way. In this specific example, only the side opening of block 10d is configured to receive the portion of the connector body 36a. In this example, the second fastener is a screw which is inserted into one of the holes 38 of the portion of the connector body 36a when it is received in the side opening of block 10d. In this way, the screw is configured to removably secure the connector body 36b in the port of the block 10d. As shown in FIG. 4E, the connector 30 can be secured in any one of the plurality of positions. The plurality of apertures 38 are each configured to receive the screw and attach the connector to the block 10d. The distance between the blocks 10c, 10d depends on which aperture the fastener is connected to.

In examples not shown, the fastener of any embodiment may instead be a spring-loaded latch. The spring-loaded latch can be configured such that, once the first or second opening has received the at least a portion of the connector, the at least a spring is compressed. The constant pressure from the spring provides a reliable hold between the at least a portion of the connector and the first block, securing them together.

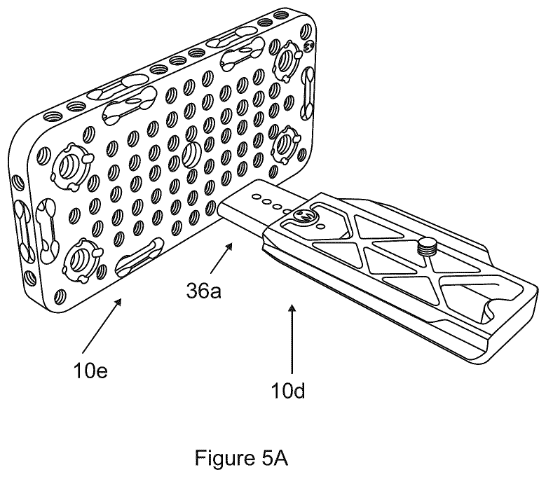

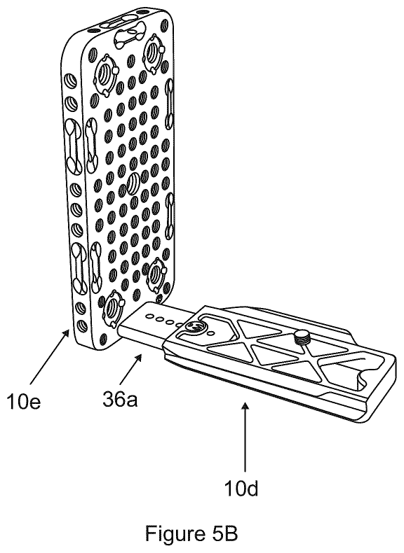

FIGS. 5A and 5B show an embodiment of the present invention comprising a different side element to that shown in FIGS. 4A to 4D, but the same base plate. FIG. 5A shows a first configuration of these elements and FIG. 5B shows a second configuration of these elements. Blocks 10d, 10e are secured together using the connector shown in FIG. 4E.

As shown in FIGS. 2 to 4D and FIGS. 5A to 7, there are a number of different types of first and/or second blocks which may be included in the present modular system 1. Blocks may be designed based on the purpose and functionality of the modular system 1.

For examples, FIG. 2A shows two blocks 10a, 10b having a number of different holes arranged across the top face of the blocks 10a 10b. These holes are through holes extending to the bottom face of each block 10a 10b. These holes are a collection of first holes having a first diameter and second holes having a second diameter, wherein the second diameter is smaller than the first diameter. The arrangement of these holes across the top face of the blocks 10a 10b has been designed for the purpose of providing a versatile plate of a photographic assembly that may be attached, using said holes, to various other photographic components. These holes include one or more threaded bores and/or QD ports.

For example, block 10c shown in FIGS. 4A-4D has three larger holes aligned along the longitudinal axis of the block 10c. In various examples, at least two of these holes are configured such that the block 10c may be attached to a support, such as a tripod. In this way, block 10c is particularly useful in photographic assemblies where the user may wish to alter the orientation of the camera relative to the support. Similarly, there are a number of smaller holes distributed across the block 10c which can be used for attachment to a support.

The central hole of example block 10c shown in FIGS. 4A-4D is a QD port. Any combination of threaded bores and QD ports is able to be provided for these large holes.

In some examples, the blocks 10a, 10b may have holes arranged to better distribute the centre of mass of the block 10a 10b. By providing holes, reduces the weight of the blocks 10a 10b and the arrangement of the holes can strategically distribute the weight as desired. Alternative hole designs are shown in FIGS. 5A-5B.

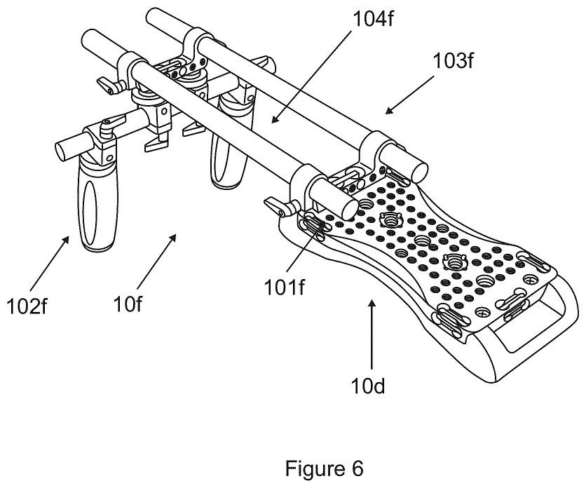

The blocks of an aspect are not limited to plates and may be any suitable component of the assembly. FIG. 6 shows show an example of an aspect comprising a base plate 10d and a side element 10f. This shows a shoulder mountable rest or plate to which handles are attachable using the modular assembly described herein.

In the example shown in FIG. 6, the side element 10f comprises pan bar handles allowing the user to move the camera left to right smoothly. As shown, two bars 103f and 104f are secured at a first end to an attachment portion 101f and attached at a second end to a handle portion 102f. The attachment portion 101f comprises a port 20 having a first and second opening, each opening configured to receive a portion of the connector 30. The received portion of the connector is fastened to the attachment portion 101f. Similarly, a second portion of the connector is fastened to the base plate 10d.

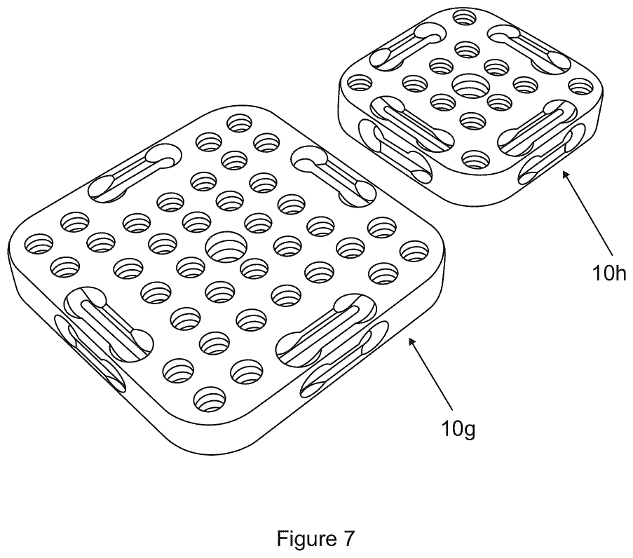

Similarly to the type of components of the present system are not limited, the size of the blocks of the present invention are not limited to a particular size or shape and may be any suitably sized and shaped component of the assembly. FIG. 7 shows two alternative blocks according to an aspect. These blocks are square in shape and have different sizes to one another.

In general, the blocks shown in the figures have sizes in the range of about 1 cm to about 30 cm to 40 cm in their longest dimension. Various examples provide blocks with a thickness of the order of about 0.2 cm to about 5 cm to 10 cm. The openings for the ports in several examples have a width in the face of the respective block of about 2 cm to 3 cm.

As can be seen from FIGS. 6 and 7, as well as form other figures, the blocks can be various shapes, such as with bar holders (as shown in FIG. 7). A number of variations can be envisaged that still hold to the core of an aspect.

1. A modular system for attachment of blocks of a connection assembly comprising:
at least two blocks comprising a first block and a second block;
a connector configured to secure the first block and the second block together;
wherein the first block comprises a port having a first opening on a first face and a second opening on a second face, wherein at least one of the first opening and second opening is configured to receive at least a portion of the connector; and
a first fastener configured to engage each of the connector and the port of the first block to removably secure the connector in the port; and
wherein the first opening and the second opening are each configured to receive at least a portion of the connector and wherein the first face and second face are connecting faces of the first block.

2. The modular system according to claim 1, wherein the port comprises a through-hole extending between at least the first opening and the second opening.

3. A modular system according to claim 2, wherein the first opening and the second opening are arranged such that, when at least a portion of the connector is received by one of the first opening or second opening, the other of the first opening or second opening is able to receive the fastener for engagement with the connector.

4. The modular system according to claim 3, wherein the first fastener is a screw.

5. The modular system according to claim 1, wherein the connector comprises a flange portion arranged such that, when the at least a portion of the connector is received by one of the first opening or second opening, the flange portion is located between the first block and the second block.

6. The modular system according to claim 1, wherein the port comprises a third opening arranged on a third face of the said block.

7. The modular system according to claim 6, wherein the third opening is configured to receive at least a portion of the connector.

8. The modular system according to claim 1, wherein the second block comprises a port having a first opening on a first face and a second opening on a second face, wherein at least one of the first opening and second opening is configured to receive at least a portion of the connector; and
a second fastener is configured to engage each of the connector and the second port of the second block to removably secure the connector in the port of the second block.

9. The modular system according to claim 8, wherein the connector is configured such that at least one of the first opening and second opening of the first block receives a first portion of the connector and at least one of the first opening and second opening of the second block receives a second portion of the connector.

10. The modular system according to claim 1, wherein at least one of the first block and second block comprise a plurality of ports.

11. A modular system according to claim 1, wherein the connector comprises an extension plate portion and the second block is a base plate, wherein the extension plate portion is securable to the second block in a plurality of positions, an amount of overlap of the extension plate portion and the second block being determined by the position in which the extension plate portion is secured to the second block, the position of the first block relative to the second block thereby being movable.

12. A modular system according to claim 1, wherein at least one of the first and second block is a plate.

13. A modular system according to claim 12, wherein the plate is one of: a base plate of a photographic assembly, and a side plate of the photographic assembly.

14. A modular system according to claim 1, wherein the at least one of the first and second block is a side element of a photographic assembly.

15. The modular system according to claim 2, wherein the connector comprises a flange portion arranged such that, when the at least a portion of the connector is received by one of the first opening or second opening, the flange portion is located between the first block and the second block; wherein the port comprises a third opening arranged on a third face of the said block; wherein the second block comprises a port having a first opening on a first face and a second opening on a second face, wherein at least one of the first opening and second opening is configured to receive at least a portion of the connector; and a second fastener is configured to engage each of the connector and the second port of the second block to removably secure the connector in the port of the second block.

16. The modular system according to claim 15, wherein the connector comprises an extension plate portion and the second block is a base plate, wherein the extension plate portion is securable to the second block in a plurality of positions, an amount of overlap of the extension plate portion and the second block being determined by the position in which the extension plate portion is secured to the second block, the position of the first block relative to the second block thereby being movable.

17. The modular system according to claim 3, wherein the connector comprises a flange portion arranged such that, when the at least a portion of the connector is received by one of the first opening or second opening, the flange portion is located between the first block and the second block; wherein the port comprises a third opening arranged on a third face of the said block; wherein the second block comprises a port having a first opening on a first face and a second opening on a second face, wherein at least one of the first opening and second opening is configured to receive at least a portion of the connector; and a second fastener is configured to engage each of the connector and the second port of the second block to removably secure the connector in the port of the second block.

18. The modular system according to claim 17, wherein the connector comprises an extension plate portion and the second block is a base plate, wherein the extension plate portion is securable to the second block in a plurality of positions, an amount of overlap of the extension plate portion and the second block being determined by the position in which the extension plate portion is secured to the second block, the position of the first block relative to the second block thereby being movable.

19. The modular system according to claim 4, wherein the connector comprises a flange portion arranged such that, when the at least a portion of the connector is received by one of the first opening or second opening, the flange portion is located between the first block and the second block; wherein the port comprises a third opening arranged on a third face of the said block; wherein the second block comprises a port having a first opening on a first face and a second opening on a second face, wherein at least one of the first opening and second opening is configured to receive at least a portion of the connector; and a second fastener is configured to engage each of the connector and the second port of the second block to removably secure the connector in the port of the second block.

20. The modular system according to claim 19, wherein the connector comprises an extension plate portion and the second block is a base plate, wherein the extension plate portion is securable to the second block in a plurality of positions, an amount of overlap of the extension plate portion and the second block being determined by the position in which the extension plate portion is secured to the second block, the position of the first block relative to the second block thereby being movable.
